(19) United States
(12) Patent Application Publication
(10) Pub. No.: US 2008/0001381 A1
(43) Pub. Date: Jan. 3, 2008

(54) Children's bicycle seat with adjustable mounting

(76) Inventor: Christopher Adam James Courtois, Haleiwa, CA (US)

Correspondence Address: MICHAEL A. GUTH, 2-2905 EAST CLIFF DRIVE, SANTA CRUZ, CA, 95062, US

(21) Appl. No.: 11/479,033

(22) Filed: Jul. 1, 2006

(51) Int. Cl. B62J 1/16

(52) U.S. Cl. 280/202

(57) ABSTRACT

A bicycle seat with an adjustable mounting system adapted to allow for mounting to a variety of bicycles. The mounting system has a rotatable bracket which allows for secure mounting to bicycles with different neck and stem geometries. A bicycle seat with caged footguards.

### BACKGROUND OF THE INVENTION

1. Field of Invention

The present invention related generally to the field of bicycle accessories, and more specifically to a children's bicycle seat with an adjustable mounting system.

2. Description of Related Art

Various aftermarket children's bicycle seats are known in the art. Typically, a children's bicycle seat is designed to be attached to a bicycle ridden by an adult. Some bicycle seats are adapted to sit behind the primary seat of the bicycle. Other seats are adapted to be fastened in front of the adult rider in the area of the handlebars.

A difficulty with aftermarket seats, especially those adapted for fastening in the area of the handlebars of an adult's bicycle, is that there are a variety of frame, gooseneck, and handlebar geometries. A prior art device adapted for the Asian market involved fixed mounting clips which clipped a children's seat behind the handlebars of a bicycle. In the geographic regions where this seat was used, there was a uniformity of bicycle type and size, in part related to the uniformity of the size of the population of the region and in part due to the lack of specialization of bicycle types. The gooseneck of a bicycle is defined by at least two dimensions, the vertical aspect which involves the stem, and the horizontal aspect which involves the neck. In populations with smaller physical sizes, the neck of the bicycle may be as small as zero inches, and is typically less than one inch.

In today's market, there is a great variety of geometries in bicycles and especially in goosenecks. For example, two parents in the same family may have distinctly different bicycle types. The father typically is larger and his bicycle may have a bigger geometry, including a longer horizontal distance of the neck of the gooseneck, perhaps up to six inches. The mother's bicycle may be smaller, with a horizontal distance of the neck being from zero to two inches.

FIGS. 1A-B illustrate two cases of differing gooseneck geometries. A bicycle 10 with a short neck section of the gooseneck 11 is seen if FIG. 1A. The stem 12 portion of the gooseneck 111 extends vertically from the headset of the bicycle. The neck 14 is very short in this embodiment and the handlebar interface 13 is a very short distance horizontally from the axis of the neck 12. The handlebars are not shown for clarity. A bicycle 20 with a longer neck section of the gooseneck 21 is seen in FIG. 1B. The stem 22 portion of the gooseneck 21 extends vertically from the headset of the bicycle. The neck 24 is seen to be longer than the preceding case and places the handlebar interface 23 further forward horizontally.

FIG. 2 illustrates the limitations of the prior art device. A bicycle 40 with a gooseneck 42 with a very limited horizontal neck is seen. The front support 43 of the children's bicycle is seen without the seat, which would typically be attached to and rearward of the front support. The front support has two vertical tubes, each of which has a clip 44 attached with two rivets 46. The clips 44 are adapted to hang over the handlebar 45. The front support is further attached to the stem of the gooseneck with a cross support 47, typically a bar and clip, which restricts any rotational motion of the front support 43 around the handlebar 45. Note that the geometry of the clip 44 to the front support 43 is preset and non-adjustable. Also, the geometry of the device depends upon a short to non-existent horizontal length of the neck.

For a children's bicycle seat that is to be clipped to the handlebars, but also to be attached to the stem of the gooseneck, these varying geometries render prior art designs unusable. What is called for is a bicycle seat that can be attached to handlebars of various geometries. What is also called for is a children's bicycle seat with an adjustable mount system that allows the seat to be used with different bicycles.

### BRIEF SUMMARY OF THE INVENTION

A bicycle seat with an adjustable mounting system adapted to allow for mounting to a variety of bicycles. The mounting system has a rotatable bracket which allows for secure mounting to bicycles with different neck and stem geometries. A bicycle seat with caged footguards.

### BRIEF DESCRIPTION OF THE DRAWINGS

FIGS. 1A-B are partial views of bicycles illustrating differing gooseneck geometries.

FIG. 2 is a partial side view of a prior art mounting method for a handlebar mounted children's bicycle seat.

FIG. 3 is a side view of a children's bicycle seat with an adjustable mounting system according to some embodiments of the present invention.

FIG. 4 is an oblique rear view of a children's bicycle seat with an adjustable mounting system according to some embodiments of the present invention.

FIG. 5 is a front view of a children's bicycle seat with an adjustable mounting system according to some embodiments of the present invention.

FIG. 6 is a photograph of a children's bicycle seat mounted on a bicycle according to some embodiments of the present invention.

FIG. 7 is a photograph of a children's bicycle seat mounted on a bicycle according to some embodiments of the present invention.

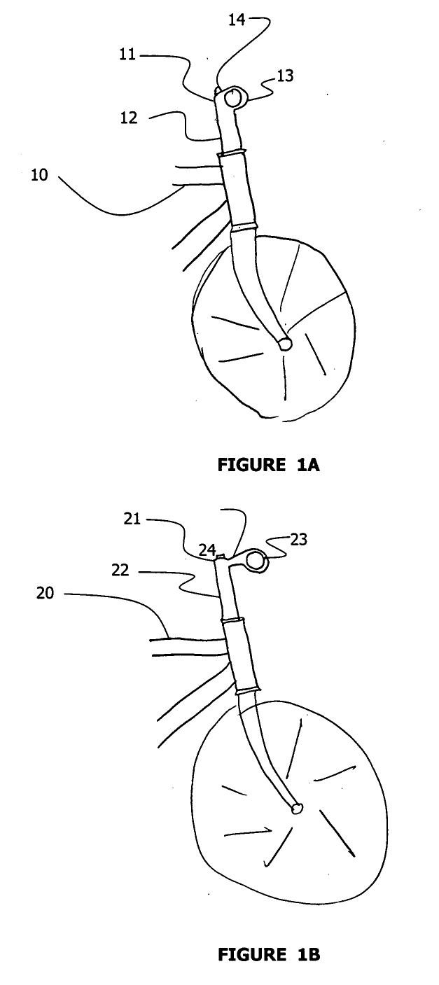

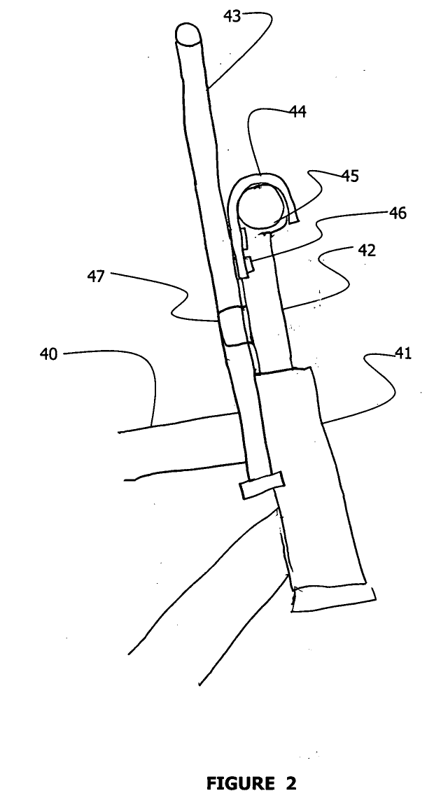

### DETAILED DESCRIPTION

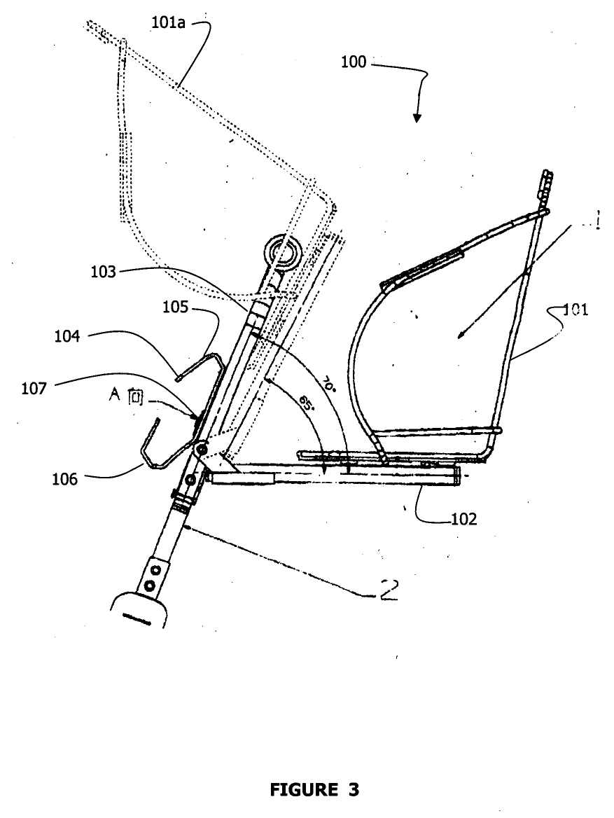

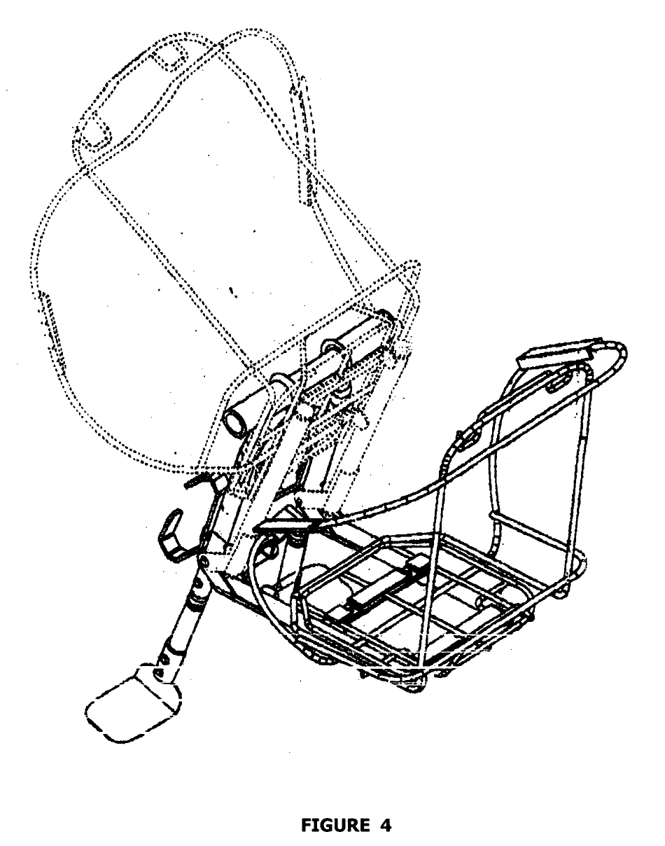

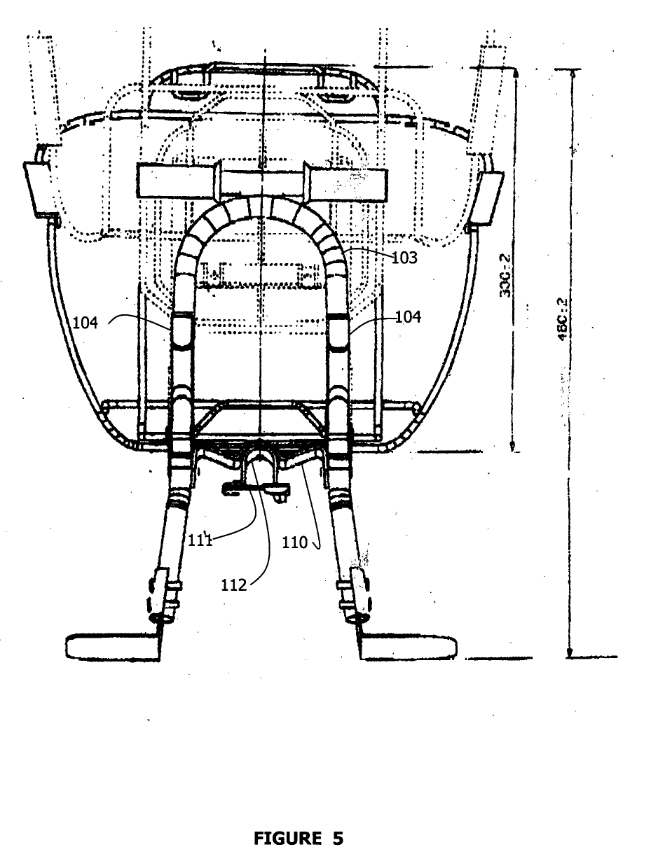

FIGS. 3 and 5 illustrate side and front views, respectively, of a bicycle seat 100 according to some embodiments of the present invention. The bicycle seat 100 is adapted to be supported from the handlebars of a bicycle and also to press against the stem of gooseneck of the bicycle. A seat 101 is attached to a main support 102, which in turn is attached to the front support 103. The front support 103 is in the shape of an upside down U in some embodiments, with each side of the U being an upright support. The geometry of the front support thus allows for the clipping of two rotatable clips 104 to the handlebars of the bicycle, which each clip on either side of the gooseneck attachment to the handlebars. The handlebars of the bicycle provide the vertical support which supports the front support 103. Rotation around the axis of the handlebars is prevented by the attachment of the cross support 110 to the stem of the bicycle's gooseneck. The stem sits in a depression 112 in the cross support 110 and may be secured with a clip 111. As seen in FIG. 3, the seat may be hinged at the interface of the main support 102 to the front support 103 to a folded position 101a, which may be convenient for storage.

The front support provides for the mounting of the bicycle seat 100 to the bicycle, and also provides handholds for the child at the top of the front support. The bottom of the front support may include horizontal foot pegs which are utilized by the feet of the child sitting in the seat.

The preferred horizontal disposition of the main support allows for the proper seat geometry. The relative position of the clip, which clips onto the handlebars to the cross support which attaches behind the headset, will set the disposition and angle of the main support. Because of differing geometries of bicycle goosenecks, a single clip position is not adequate for a seat that is to be used for more than one bicycle type. The rotatable clips 104 are attached to the upright supports of the front support. The rotatable clips 104 are rotatable about a pivot 107 which is also the attach point of the rotatable clip 104 to the upright support of the front support 103. Rotation of the clips allows for proper mounting of the bicycle seat to bicycles with differing gooseneck geometries. The three attachment points, those of the two clips and of the cross support, all of which are removeably secured attachment points, provide firm and adequate mounting of the seat to the bicycle.

As seen in FIG. 3, a first end 105 of the rotatable clip 104 is in position to clip onto a handlebar. The first end 105 includes a clip that is in close proximity to the front support, and is adapted to mount to a gooseneck which has a short neck, from zero to two inches. A second end 106 of the rotatable clip 104 is, as seen in FIG. 3, not in position to be used. However, with the easy rotation of the rotatable clip 104 around its pivot 107, the second end 106 would be in proper position to be used to attach to a bicycle handlebar. The second end 106, as seen in the side view of FIG. 3, is adapted to be used with a gooseneck which has a long neck, which could be in the range of two to six inches, and still maintain an appropriate position of the main support and the seat.

Thus, the adjustable mounting system on the bicycle seat allows for adjustment of the seat for the use with different bicycles of different geometry. As seen in FIG. 7, which is photograph of a seat mounted onto handlebars according to some embodiments of the present invention, the rotatable clips 104 not only clip over the handlebars, but are also constrained from removal from the handlebars by fasteners 130. The fasteners 130 thread through threaded holes 131 in the clips. The fasteners may be used only on the portion of the clip rotated into position and being used, dependant upon the bicycle geometry. Also seen is the cross support 110, which also has a clip 111 locking the cross support 110 to the stem of the gooseneck of the bicycle. With the two fasteners 130 and the clip of the cross support in place, the seat is firmly and safely mounted to the handlebars.

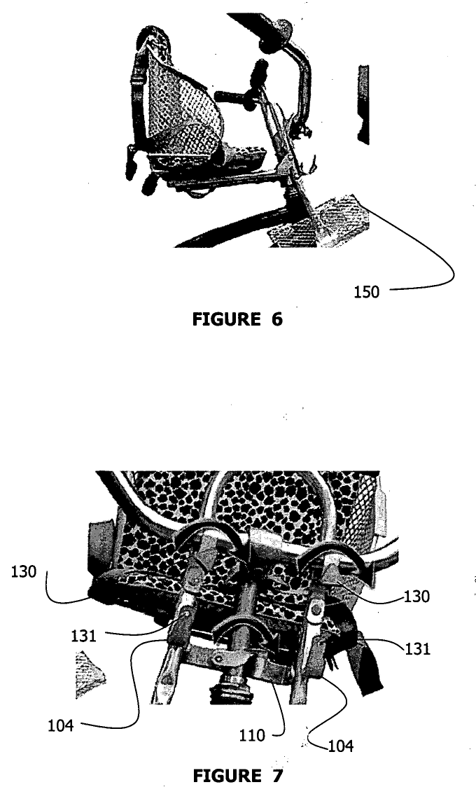

FIG. 6 illustrates a caged footguard 150 which improves safety for the child in the seat. Whereas earlier version of seats had merely pegs which splayed out horizontally from the front support, mesh cages have been added along the inner side of the foot area to increase support and safety.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A bicycle seat comprising:
a seat portion, said seat portion attached to a front support;
a front support, said front support adapted to support said seat portion; and
an adjustable front mount system, said front mount system adapted to clip onto the handlebars of a bicycle.

2. The bicycle seat of claim 1 wherein said adjustable front mount system comprises a first rotatable clip fastened to said front support.

3. The bicycle sear of claim 2 wherein said adjustable from mount system comprises a second rotatable clip fastened to said front support.

4. The bicycle seat of claim 3 wherein said front support comprises a first upright support and a second upright support.

5. The bicycle seat of claim 4 wherein said first rotatable clip is fastened to said first upright support of said front support, and wherein said second rotatable clip is fastened to said second upright support of said front support.

6. The bicycle seat of claim 2 wherein said first rotatable clip is attached to said front support at the point around which said first rotatable clip rotates.

7. The bicycle seat of claim 6 wherein said first rotatable clip comprises a first end and a second end, wherein said first end includes a clip in close proximity to said front support, and wherein said second end includes a clip significantly further from said front support than said clip on said first end.

8. A bicycle seat adapted for mounting to the handlebar area of a bicycle, said bicycle seat comprising:
a main horizontal support;
a seat mounted on said main horizontal support;
a front support, said front support connected to said main horizontal support;
a cross support, said cross support connected to said front support; and
one or more mounting clips, said mounting clips attached to said front support, said mounting clips adapted to allow adjustment for varying mounting geometries.

9. The bicycle seat of claim 8 wherein said mounting clips comprise a first end and a second end, wherein said mounting clips are attached to said front support at a pivot point, said pivot point in between said first end and said second end.

10. The bicycle seat of claim 9 wherein said first end of said mounting clips have a first geometry, and wherein said second end of said mounting clips have a second geometry.

11. The bicycle seat of claim 10 wherein said first geometry includes a clip feature adapted to suspend said bicycle seat from a tube directly adjacent to said front support.

12. The bicycle sear of claim 11 wherein sad second geometry includes a clip feature adapted to suspend said bicycle seat from a tube two or more inches from said front support.

13. The bicycle seat of claim 8 further comprising foot pegs, said foot pegs attached to said front support.

14. The bicycle seat of claim 13 further comprising caged footguards, said caged footguards attached to said front support, said caged footguards adjacent to said foot pegs.
